(19) United States
(12) Patent Application Publication
(10) Pub. No.: US 2025/0354299 A1
(43) Pub. Date: Nov. 20, 2025

(54) Electrospinning Apparatus and Uses Thereof

(71) Applicant: University of Connecticut, Farmington, CT (US)

(72) Inventors: Cato T. Laurencin, Avon, CT (US); Nikoo Saveh-Shemshaki, Cranston, RI (US); Amir A. Abedini, Hartford, CT (US); Ehsan Norouzi, Cranston, RI (US); Lakshmi S. Nair, New Britain, CT (US)

(73) Assignee: University of Connecticut, Farmington, CT (US)

(21) Appl. No.: 19/213,690

(22) Filed: May 20, 2025

Related U.S. Application Data
(60) Provisional application No. 63/649,597, filed on May 20, 2024.

(51) Int. Cl. D01D 5/00

(52) U.S. Cl. CPC D01D 5/0084

(57) ABSTRACT

An electrospinning apparatus includes at least two reservoirs for containing a spinning dope and at least two nozzles, one on each of the reservoirs through which the spinning dope is extruded or drawn. First and second electrodes are in contact with the nozzles and generate an electrostatic field there between the first and second electrodes. A collection surface is positioned between the first and second electrodes. The apparatus may include a controller and a user interface to control parameter(s) at a desired set point.

### CROSS-REFERENCE TO RELATED APPLICATION

This application claims priority benefit to a US provisional patent application entitled “Electrospinning Apparatus and Uses Thereof” which was filed on May 20, 2024, and assigned Ser. No. 63/649,597. The entire content of the foregoing US provisional patent application is incorporated herein by reference.

### GOVERNMENT SUPPORT

This invention was made with government support under AR068147 awarded by the National Institutes of Health, and 1332329 awarded by the National Science Foundation. The government has certain rights in the invention.

### FIELD OF THE DISCLOSURE

The invention disclosed herein relates to an electrospinning apparatus/device/system and methods/uses thereof and, in particular, an electrospinning apparatus that includes dual electrospinning for coating industrial microfibers and prefabricated grafts with synthetic and natural polymer-based nanofibers.

### BACKGROUND

Although fibers that are produced by a conventional extrusion method are robust, this method does not allow for the production of fibers with dimensions of approximately 10-15 microns or smaller. Moreover, while technology that is based on twisting electrospun sheets may aid in fabricating yarns with a nanostructure, the resulting mechanical properties of these yarns are inferior compared to those made using the extrusion technique.

There is an immediate need for a novel electrospinning apparatus/device/system to produce durable microfibers and/or grafts.

### SUMMARY

An object of the present invention is to provide an electrospinning apparatus capable of large-scale coating of industrial microfibers and prefabricated three-dimensional grafts with synthetic and/or natural polymer-based nanofibers.

In an aspect, electrospinning apparatus, devices and systems are provided that facilitate coating of microfibers and three-dimensional grafts with synthetic and/or natural polymer-based nanofibers.

In an aspect, the electrospinning apparatus/devices/systems facilitate coating of industrial microfibers and prefabricated three-dimensional grafts with synthetic and/or natural polymer-based nanofibers.

In an aspect, a method of electrospinning is provided to coat nanofibers, such as industrial microfibers and prefabricated grafts, with synthetic and natural polymer-based nanofibers.

These and other aspects of the present invention are described in more detail below.

### BRIEF DESCRIPTION OF THE FIGURES

To assist those of skill in the art in making and using the disclosed apparatus/device/system and methods/uses, reference is made to the accompanying figures, wherein:

FIG. 1 is a schematic depiction of an electrospinning system;

FIG. 2 is a schematic depiction of an alternative electrospinning system;

FIG. 3 is schematic depiction of an electrospinning system that includes four (4) pumps.

FIG. 4 shows an electrospinning apparatus for use in coating fibers with nanofibers, with an enlarged view of a portion of the electrospinning apparatus;

FIG. 5 is a scanning electron micrograph that shows both coated and non-coated areas of poly-L-lactic acid (PLLA) yarns;

FIG. 6A and FIG. 6B are scanning electron micrographs showing non-coated industrial yarns;

FIG. 6C and FIG. 6D are scanning electron micrographs showing industrial yarns coated with PLLA nanofibers;

FIG. 6E and FIG. 6F are scanning electron micrographs showing industrial yarns coated with gelatin nanofibers;

FIG. 7A (photograph) and FIG. 7B (scanning electron micrograph) show an uncoated graft made from conventional PLLA micro-yarns;

FIG. 7C (photograph) and FIG. 7D (scanning electron micrograph) show a graft made from PLLA micro-yarns coated with PLLA nanofibers;

FIGS. 8A-8C are photographs showing three stages of a coating process; FIG. 8A shows fixing of the solid graft prior to coating; FIG. 8B shows coating of the graft; and FIG. 8C shows the coated graft;

FIGS. 9A-9C are scanning electron micrographs showing gelatin coatings at different concentrations;

FIGS. 10A-10G are a series of images showing a coated braided graft region, a bare graft region and the interface therebetween;

FIG. 11 is a plot showing stress-strain properties of a coated and an uncoated yarn;

FIG. 12 is a plot showing proliferation and viability of C2C12 cells for industrial yarns and nanofiber coated yarns after 24 hours;

FIG. 13 is a plot showing proliferation and viability of C2C12 cells for industrial yarns and nanofiber coated yarns after 48 hours;

FIGS. 14A-14C are images of a coating process for coating of a stiff graft;

FIG. 15A is a schematic depiction of an electrospinning system for fabricating a hollow structure;

FIG. 15B and FIG. 15C are schematic depictions of hollow structures fabricated according to the electrospinning system of FIG. 15A;

FIGS. 16A and 16B are images of a graft before coating (photograph and optical microscope image, respectively);

FIGS. 16C and 16D are images of a graft after coating with curcumin containing PLLA nanofibers (photograph and optical microscope image, respectively); and

FIG. 17A is a schematic depiction of a tube with an opening in its side before coating;

FIG. 17B is a schematic depiction of the tube of FIG. 17A after coating;

FIG. 18A shows a PLLA yarn on a twister that is coated with curcumin drug-containing PLLA nanofibers;

FIG. 18B shows a knitted graft made with the PLLA yarn coated with curcumin drug-containing PLLA nanofibers shown in FIG. 18A;

FIG. 19A shows a suture made from a curcumin-PLLA nanofiber coated yarn;

FIGS. 19B-19E show a cadaveric rat sutured with the yarn of FIG. 19A;

FIG. 20A shows fabrication of PLLA nanofiber-based tube using a sacrificial filament to provide a hollow tube; and

FIG. 20B and FIG. 20C show the hollow tube fabricated using a sacrificial filament as shown in FIG. 20A.

### DETAILED DESCRIPTION

Before the disclosed processes and devices are described, it is to be understood that the aspects described herein are not limited to specific embodiments, or examples, and as such can, of course, vary. It is also to be understood that the terminology used herein is for the purpose of describing particular aspects only and, unless specifically defined herein, is not intended to be limiting.

In the technique of electrospinning, an electrostatic force is generally used to draw fine jets of dope from the reservoir. Dope held by surface tension at the nozzle is subjected to an electrostatic field that induces a charge at the surface. Mutual charge repulsion causes a force directed opposite to the surface tension. When the electrostatic field intensity is sufficiently strong, forces on the surface of the dope at the tip of the nozzle overcome the surface tension, the surface elongates, and makes a fine jet in the direction of the applied field (perpendicular to the liquid surface). As the jet travels towards the electrode of the applied voltage, the dope is collected as a non-woven mesh of fine fibers. The conventional electrospinning apparatus has a plate, screen, or a rotating mandrel positioned beneath the nozzle that is connected to the bottom electrode. Therefore, the pattern of fibers that are produced is in accordance with an undisturbed electrostatic field.

In an aspect, an electrospinning apparatus is provided that includes (i) a plurality of twisters; (ii) a plurality of reservoirs configured to contain a spinning dope; (iii) a plurality of nozzles adjacent to the reservoir through which spinning dope is extruded or drawn; (iv) a plurality of electrodes, wherein each electrode is in contact with at least one nozzle; (v) a power supply connected to at least two of the electrodes, wherein the power supply is configured to generate an electrostatic field between the two electrodes; (vi) at least one collection surface located between the pair of electrodes; and (vii) a control panel.

The plurality of twisters may include at least two twisters, e.g., a feeding twister and a collecting twister.

The plurality of reservoirs may include one or more syringes. The plurality of reservoirs may total, for example, at least two reservoirs, at least four reservoirs, or at least six reservoirs.

The plurality of nozzles may include a plurality of syringe needles, for example, at least two syringe needles, at least four syringe needles, or at least six syringe needles.

The at least one collection surface may be, for example, an aluminum structure such as an aluminum cylinder.

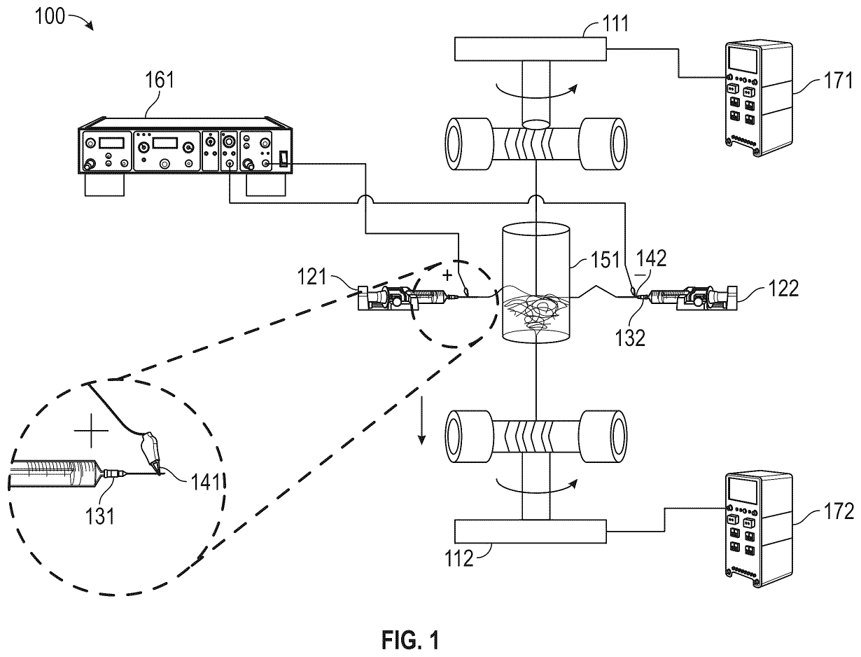

In an embodiment and with reference to FIG. 1, electrospinning system 100 includes a first twister or feeding system 111; a first reservoir or syringe 121 configured to contain a first spinning dope; a first nozzle or syringe needle 131 positioned generally adjacent to the first reservoir/syringe 121 through which the first spinning dope is extruded or drawn; a first electrode 141 in contact with the first nozzle/syringe needle 131; a second reservoir or syringe 122 configured to contain a second spinning dope; a second nozzle or syringe needle 132 positioned generally adjacent to the second reservoir/syringe 122 through which the second spinning dope is extruded or drawn; a second electrode 142 located a distance away from the first electrode 141; a power supply 161 connected to at least one of the first electrode 141 and the second electrode 142, wherein the power supply is configured to generate an electrostatic field between the first electrode 141 and the second electrode 142; a collection surface 151 (such as an aluminum cylinder) located between the first electrode 141 and the second electrode 142; a second twister or collecting system 112; a first control panel 171 to control a twisting rate of the first twister 111; and a second control panel 172 to control a twisting rate and collecting rate of the second twister 112. The exploded portion of FIG. 1 shows a connection between the first electrode 141 and the first nozzle/syringe needle 131.

In an embodiment, the first control panel 171 is the only control panel present and it controls the twisting rate of the first twister 111; and the twisting rate and collecting rate of the second twister 112. In an embodiment, the first reservoir 121 and the first nozzle 131 are controlled by and in communication with a first pump (not shown), and the second reservoir 122 and the second nozzle 132 are controlled by and in communication with a second pump (not shown).

In an embodiment, the apparatus/device/system includes plurality of collection surfaces, such as an aluminum cylinder located between the pair of electrodes. In an embodiment, for example, at least 1, 2, 3, 4, 5, 6, 7, 8, 9 or 10 collection surfaces are included.

In an embodiment, the apparatus/device/system includes a plurality of reservoirs, such as syringes. In an embodiment, the apparatus/device/system includes at least 2, 4, 6, 8, 10, 12, 14, 16, 18 or 20 reservoirs.

In an embodiment, the apparatus/device/system includes a plurality of nozzles, such as syringe needles. In an embodiment, the apparatus/device/system includes at least 2, 4, 6, 8, 10, 12, 14, 16, 18 or 20 nozzles.

In an embodiment, the apparatus/device/system includes a plurality of electrodes. In an embodiment, the apparatus/device/system includes at least 2, 4, 6, 8, 10, 12, 14, 16, 18, or 20 electrodes.

In an embodiment, the apparatus/device/system includes a plurality of pumps. In an embodiment, the apparatus/device/system includes at least 2, 4, 6, 8, 10, 12, 14, 16, 18, or 20 pumps.

In an embodiment, the first spinning dope and the second spinning dope are the same. In an embodiment, the first spinning dope and the second spinning dope are different. Various permutations and combinations of the same and different spinning dopes may be introduced to and processed by the apparatus/device/system, e.g., based on the number/arrangement of reservoirs.

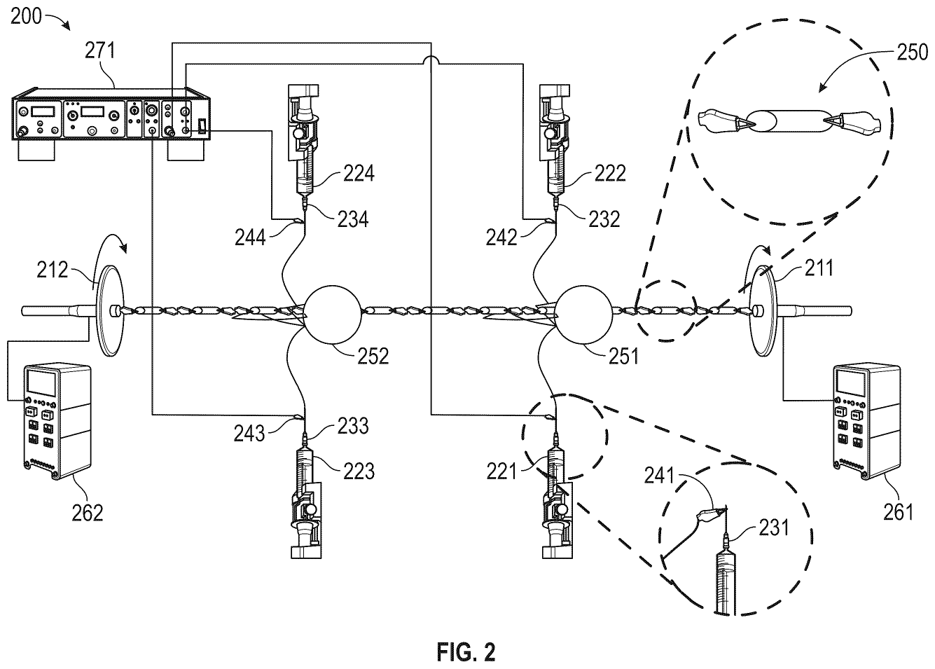

In an embodiment and with reference to FIG. 2, electrospinning apparatus 200 includes a first twister 211 (also called a feeding system); a first reservoir 221 (such as a first syringe) configured to contain a first spinning dope (not shown); a first nozzle 231 (such as a first syringe needle) positioned generally adjacent to the first reservoir 221 through which the first spinning dope is extruded or drawn; a first electrode 241 in contact with the first nozzle 231; a second reservoir 222 (such as a second syringe) configured to contain a second spinning dope (not shown); a second nozzle 232 (such as a second syringe needle) positioned generally adjacent to the second reservoir 222 through which the second spinning dope is extruded or drawn; a second electrode 242 located a distance away from the first electrode 241; a power supply 271 connected to at least one of the first electrode and the second electrode, wherein the power supply is configured to generate an electrostatic field between the first electrode and the second electrode; a first collection surface 251 (such as an aluminum cylinder) located between the first electrode 241 and the second electrode 242; a third reservoir 223 (such as a third syringe) configured to contain a third spinning dope (not shown); a third nozzle 233 (such as a third syringe needle) positioned generally adjacent to the third reservoir 223 through which the third spinning dope is extruded or drawn; a third electrode 243 in contact with the third nozzle 233; a fourth reservoir 224 (such as a fourth syringe) configured to contain a fourth spinning dope (not shown); a fourth nozzle 234 (such as a fourth syringe needle) positioned generally adjacent to the fourth reservoir 224 through which the fourth spinning dope is extruded or drawn; a fourth electrode 244 located a distance away from the third electrode 243; a second collection surface 252 (such as an aluminum cylinder) located between the third electrode 243 and the fourth electrode 244; a second twister 212 (also called a collecting system); and a first control panel 261 that facilitates control of a twisting rate of the first twister 211; and a second control panel 262 that facilitates control of a twisting rate and collecting rate of the second twister 212.

In an embodiment, flow from the first reservoir 221 to the first nozzle 231 is controlled by a first pump (not shown); flow from the second reservoir 222 to the second nozzle 232 is controlled by a second pump (not shown); flow from the third reservoir 223 to the third nozzle 233 is controlled by a third pump (not shown), and flow from the fourth reservoir 224 to the fourth nozzle 234 is controlled by a fourth pump (not shown). A first exploded portion of FIG. 2 shows a connection between the first electrode 241 and the first nozzle/syringe needle 231. The second exploded portion of FIG. 2 shows a segment 250 of a substrate to be coated.

In an embodiment, the first control panel 261 is the only control panel included in the apparatus/device/system and it controls the twisting rate of the first twister 211; and the twisting rate and collecting rate of the second twister 212.

In an embodiment, the apparatus/device/system 200 includes a plurality of collection surfaces, such as an aluminum cylinder(s), located between the pair of electrodes, for example, at least 1, 2, 3, 4, 5, 6, 7, 8, 9, or 10 collection surfaces. In an embodiment, the apparatus/system/device 200 includes (i) a plurality of reservoirs, such as syringes, (ii) a plurality of nozzles, such as syringe needles, (iii) a plurality of electrodes, and (iv) a plurality of pumps. For example, the apparatus/device/system may include at least 2, 4, 6, 8, 10, 12, 14, 16, 18, or 20 reservoirs, nozzles, electrodes, and pumps.

In an embodiment, the first spinning dope, the second spinning dope, the third spinning dope, and the fourth spinning dope are the same. In an embodiment, the first spinning dope, the second spinning dope, the third spinning dope, and the fourth spinning dope are different. In an embodiment, the first spinning dope and the second spinning dope are the same, and the third spinning dope and the fourth spinning dope are the same. Various permutations and combinations of the same and different spinning dopes may be included in the apparatus/device/system, e.g., based on the combination of reservoirs included therein.

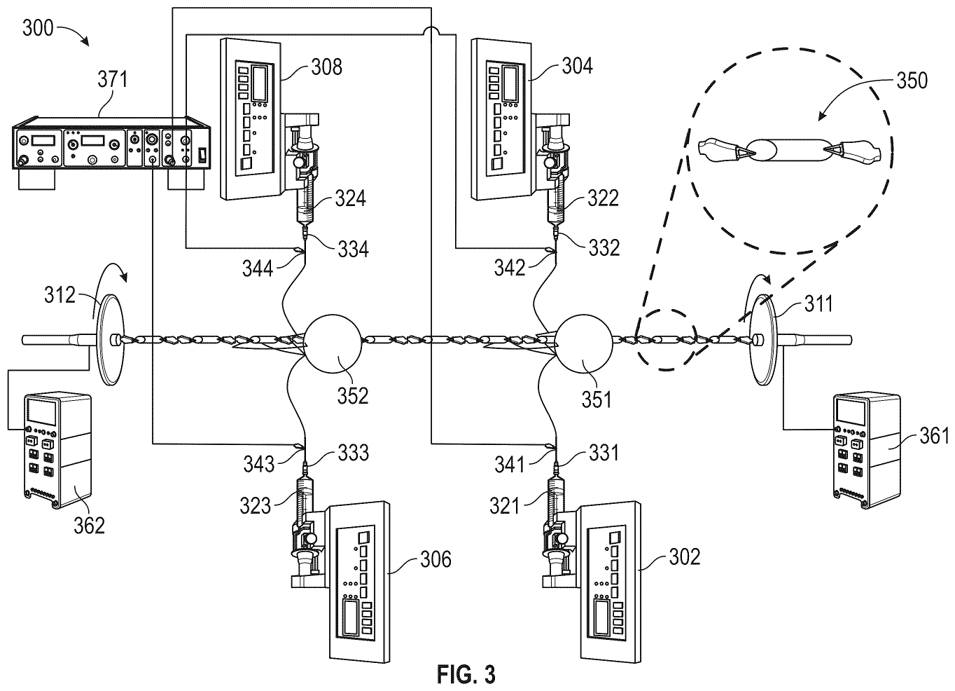

In an embodiment and with reference to FIG. 3, electrospinning apparatus 300 includes a first twister 311 (also called a feeding system); a first reservoir 321 (such as a first syringe) configured to contain a first spinning dope (not shown); a first nozzle 331 (such as a first syringe needle) positioned generally adjacent to the first reservoir 321 through which the first spinning dope is extruded or drawn; a first electrode 341 in contact with the first nozzle 331; a second reservoir 322 (such as a second syringe) configured to contain a second spinning dope (not shown); a second nozzle 332 (such as a second syringe needle) positioned generally adjacent to the second reservoir 322 through which the second spinning dope is extruded or drawn; a second electrode 342 located a distance away from the first electrode 341; a power supply 371 connected to at least one of the first electrode and the second electrode, wherein the power supply is configured to generate an electrostatic field between the first electrode and the second electrode; a first collection surface 351 (such as an aluminum cylinder) located between the first electrode 341 and the second electrode 342; a third reservoir 323 (such as a third syringe) configured to contain a third spinning dope (not shown); a third nozzle 333 (such as a third syringe needle) positioned generally adjacent to the third reservoir 323 through which the third spinning dope is extruded or drawn; a third electrode 343 in contact with the third nozzle 333; a fourth reservoir 324 (such as a fourth syringe) configured to contain a fourth spinning dope (not shown); a fourth nozzle 334 (such as a fourth syringe needle) positioned generally adjacent to the fourth reservoir 324 through which the fourth spinning dope is extruded or drawn; a fourth electrode 244 located a distance away from the third electrode 343; a second collection surface 352 (such as an aluminum cylinder) located between the third electrode 343 and the fourth electrode 344; a second twister 312 (also called a collecting system); and a first control panel 361 that facilitates control of a twisting rate of the first twister 311; and a second control panel 362 that facilitates control of a twisting rate and collecting rate of the second twister 312.

In an embodiment, flow from the first reservoir 321 to the first nozzle 331 is controlled by a first pump 302; flow from the second reservoir 322 to the second nozzle 332 is controlled by a second pump 304; flow from the third reservoir 323 to the third nozzle 333 is controlled by a third pump 306, and flow from the fourth reservoir 324 to the fourth nozzle 334 is controlled by a fourth pump 308. An exploded portion of FIG. 3 shows a segment 350 of a substrate to be coated.

In an embodiment, apparatus/device/system 300 may include at least 2, 4, 6, 8, 10, 12, 14, 16, 18 or 20 reservoirs, nozzles, and pumps, e.g., depending on type(s) of materials to be coated.

In an embodiment, the collection surface of the apparatus/device/system defines a plane, i.e., is generally planar in geometry. In an embodiment, the collection surface is configured to rotate relative to the associated nozzle. In an embodiment, the collection surface includes an aluminum cylinder. In an embodiment, the collection surface includes a cylindrical mandrel.

In an embodiment, the electrospinning apparatus/device/system includes at least two power supplies and further includes means to control voltage generated by the first power supply, the second power supply, or both the first power supply and the second power supply.

In an embodiment, the electrospinning apparatus/device/system further includes fibers deposited on the collection surface.

In an embodiment, the conductive material of the collection surface includes a plurality of conductive layers. The conductive layers may be aligned parallel to each other. The deposited fibers may be aligned into (i) arrays of non-random fibers and (ii) random fibers between the arrays of non-random fibers that attach adjacent arrays of non-random fibers to one another.

In an embodiment, the electrospinning apparatus/device/system further includes a controller and a user interface configured to control one or more controlled parameters, e.g., at a desired set point.

In an embodiment, the electrospinning apparatus/device/system further includes a controller and an instrument configured to exercise closed-loop control of at least one variable measured by the instrument.

In an embodiment, the electrospinning apparatus/device/system further includes means to control the pressure of the spinning dope.

In an embodiment, the electrospinning apparatus/device/system further includes means to control the distance between the first electrode and the second electrode.

In an embodiment, the electrospinning apparatus/device/system further includes means to control the distance of the collection surface from the nozzle.

In an embodiment, the electrospinning apparatus/device/system further includes a controller and two or more instruments configured to exercise closed-loop control of two or more variables measured by the instruments.

In an embodiment, the electrospinning apparatus/device/system includes a first electrode and a second electrode between which an electrostatic field is generated. A collection surface may be isolated from and located between the first electrode and the second electrode.

In an embodiment, the electrospinning apparatus/device/system may include an enclosure. In an embodiment, the enclosure includes a six-sided vessel. In an embodiment, the enclosure may include one or more ports for delivering a pressurized gas to the interior of the enclosure. In an embodiment, the gas may be nitrogen, for example. Alternatively, a vacuum may be applied to the enclosure. In an embodiment, pressurized gas lines and vacuum lines may include automated valves connected to a controller to control the pressure and/or vacuum within the enclosure. In an embodiment, a reservoir is placed on the upper wall of the enclosure so that a nozzle projects downward into the enclosure.

In an embodiment and with reference to FIG. 1, the first nozzle 131 is connected to a first electrode 141, and the second nozzle 132 is connected to a second electrode 142. The first electrode 141 is grounded or at least at a potential that is lower than a second electrode 142 that is connected to the second nozzle 132. For purposes of controlling the spinning dope viscosity, temperature sensor(s) (not shown) may be positioned at the first reservoir 121 and the second reservoir 122 to measure the temperature of the first reservoir 121 and the second reservoir 122 and/or the dope inside of the first reservoir 121 and the second reservoir 122. Heating coils (not shown) may be wrapped around the exterior of the first reservoir 121 and the second reservoir 122 to maintain the reservoir and/or the dope at a predetermined temperature. Heating may be provided in various ways, e.g., by electrical heat tracing or tubing provided with a heating medium, such as a hot fluid or steam.

In an embodiment and as shown in FIG. 1, the second electrode 142 is positioned opposite to the first electrode 141 and at a distance removed from the first electrode 141. In an embodiment, the second electrode 142 is connected to a high voltage power supply (not shown) that applies a high voltage to the second electrode 142. When the first electrode 141 is at a potential lower than the second electrode 142, an electrostatic field is created between the first electrode 141 and the second electrode 142, thereby creating generally undisturbed parallel lines of electrostatic force (field lines). In an embodiment, the electrostatic field between the first electrode 141 and the second electrode 142 is interfered with, manipulated, or caused to be changed so that desired patterns are created in the electrostatic field lines of force, either by interference with or by the creation of a second electrostatic field, so that the fibers spun via the electrospinning apparatus/device/system 100 lie according to the patterns created by the interference with, the changes, or the second electrostatic field.

In an embodiment, the electrostatic field created between the first electrode 141 and the second electrode 142 is interfered with, manipulated, or changed to have a desirable pattern by a collection surface 151 that is interposed between the first 141 and the second 142 electrodes, so that the collection surface 151 is isolated from the first 141 and the second 142 electrodes. The collection surface 151 may be electrically isolated from the first 141 and the second 142 electrodes.

While representative instrumentation has been described to control various parameters of the apparatus/device/system 100, 200, 300, the electrospinning apparatus 100, 200, 300 may be adjustable in other ways. For example, the collection surface area size can be controlled by replacing the collection surfaces with others of various sizes or shapes. Further, the degree of influence of the collection surface on the electrostatic field can be controlled by selecting various dielectric materials and conductive materials. Variables that may be used to induce the greatest change in the electrostatic field magnitude and direction include: (1) the distance between the first electrode 141 and second electrode 142; (2) the distance from the nozzle to the collection surface; (3) the collection surface dielectric strength; and (4) the collection surface area.

In an embodiment, the first twister 111 and the second twister 112 operate at the same speed and in the same direction. In an embodiment, the first twister 111 and the second twister 112 operate at the same speed and in different directions. In an embodiment, the first twister 111 and the second twister 112 operate at different speeds and in the same direction. In an embodiment, the first twister 111 and the second twister 112 operate at different speeds and in different directions.

In an embodiment, the electrospinning apparatus/device/system is used to coat a material with nanofibers. In an embodiment, the electrospinning apparatus is used to coat a material with microfibers. In an embodiment, the electrospinning apparatus/device/system prevents over-twisting, breakage, or rupture of a material. In an embodiment, the electrospinning apparatus/device/system is configured to coat different types of grafts. In an embodiment, the electrospinning apparatus uses 2, 4, or 6 reservoirs, nozzles, and optionally pumps to coat yarns or grafts with different materials. In an embodiment, the coating material may be changed in the middle of the process, i.e., at a point in time after commencing the coating process and before completing the coating process, and may be used to coat different regions of the graft with different materials. In an embodiment, the electrospinning apparatus/device/system is used to prepare coated materials for enhancing the microenvironment for cells. In an embodiment, the electrospinning apparatus/device/system is used for coating symmetric grafts with nanofibers. In an embodiment, the electrospinning apparatus is used for coating a braided graft.

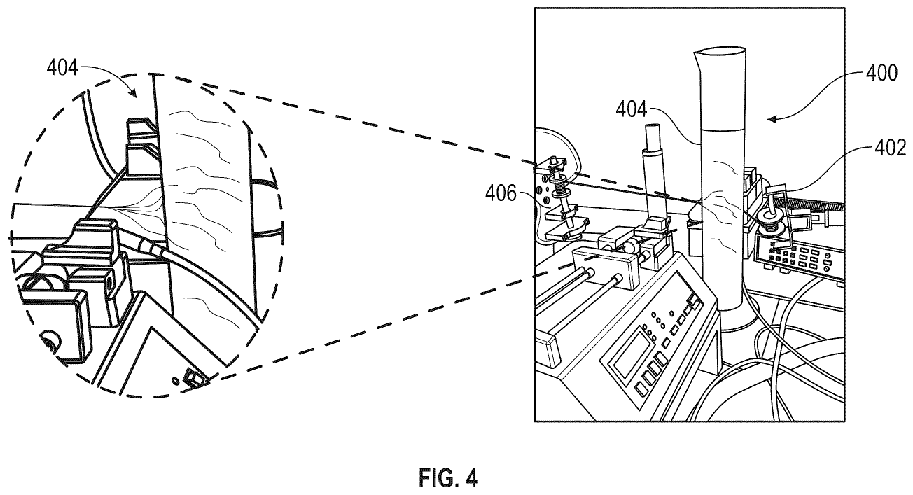

With reference to FIG. 4, an embodiment of an electrospinning apparatus/device/system 400 is shown that can be used for coating multiple fibers/yarns, e.g., industrial yarns, with nanofibers. The nanofibers may be made, for example, with different materials. Apparatus/device/system includes a feed region 402 in which the feeder bobbin (loaded with, e.g., microfibers or grafts) is twisted, and a collection region 406 in which the coated fibers are twisted and collected. The central region 404 (which is shown in the enlarged view) is where the nanofiber coating occurs.

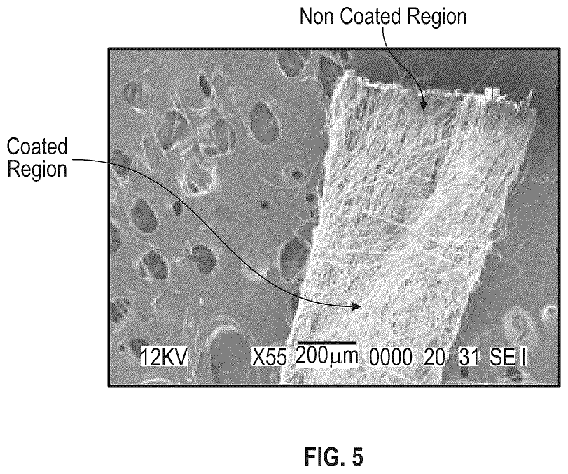

With reference to FIG. 5, a scanning electron micrograph is provided that shows both coated and non-coated areas of poly-L-lactic acid (PLLA) yarns processed with an embodiment of the disclosed electrospinning apparatus/device/system. The scanning electron micrograph shows the interface between areas coated with nanofibers and non-coated areas. The effectiveness of the disclosed electrospinning apparatus/device/system is apparent in the coated region of the scanning electron micrograph.

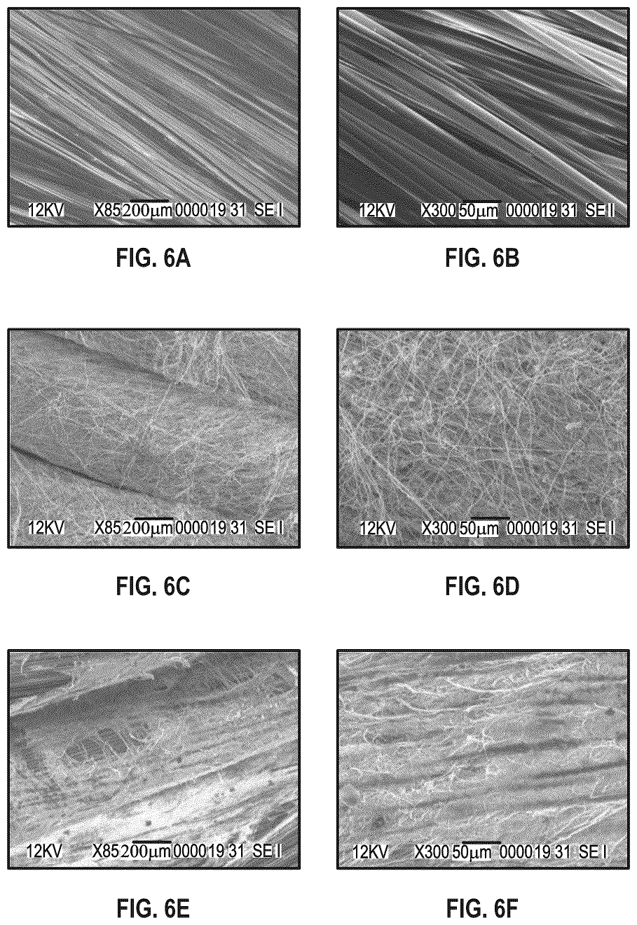

With reference to FIGS. 6A-6F, a series of scanning electron micrographs are provided showing non-coated and coated materials. FIG. 6A and FIG. 6B show non-coated industrial yarns, whereas FIGS. 6C-6F show industrial yarns that have been coated using the disclosed electrospinning apparatus/device/system. In particular, FIG. 6C and FIG. 6D show industrial yarns coated with poly-L-lactic acid (PLLA) nanofibers and FIG. 6E and FIG. 6F show industrial yarns coated with gelatin nanofibers using an embodiment of the disclosed electrospinning apparatus/device/system.

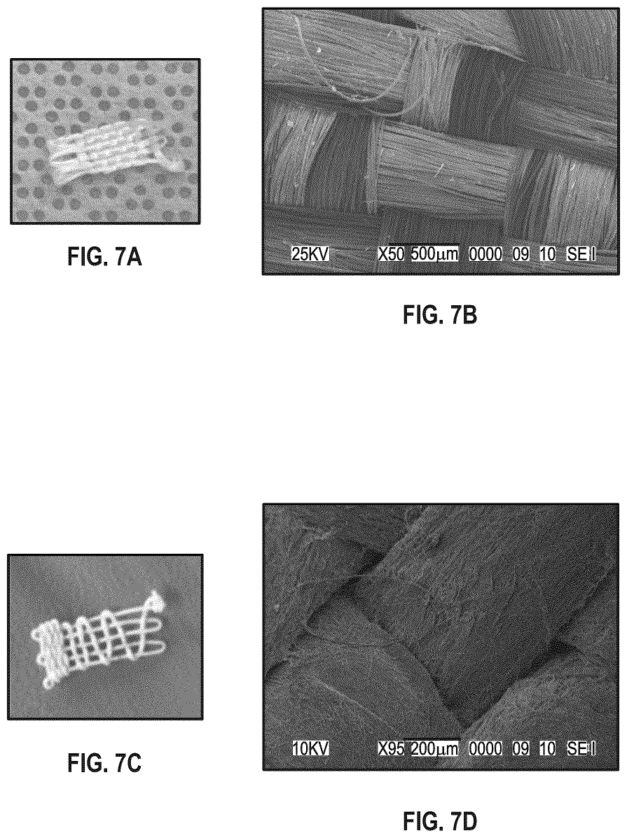

With reference to FIGS. 7A-7D, a series of photographs and scanning electron micrographs are provided showing a graft made of ordinary PLLA micro-yarns and a graft made of PLLA nanofiber-coated yarn produced using an embodiment of the disclosed electrospinning apparatus/device/system. In particular, FIG. 7A (photograph) and FIG. 7B (scanning electron micrograph) show a graft made from conventional uncoated PLLA micro-yarns, whereas FIG. 7C (photograph) and FIG. 7D (scanning electron micrograph) show a graft made from PLLA micro-yarns coated with PLLA nanofibers using an embodiment of the disclosed electrospinning apparatus/device/system,

In an embodiment, the electrospinning apparatus/device/system can coat stiff grafts, such as grafts created through 3D printing. In an embodiment, the electrospinning apparatus/device/system can perform simultaneous twisting from both ends, thereby minimizing/preventing any harm to the grafts as a result of twisting.

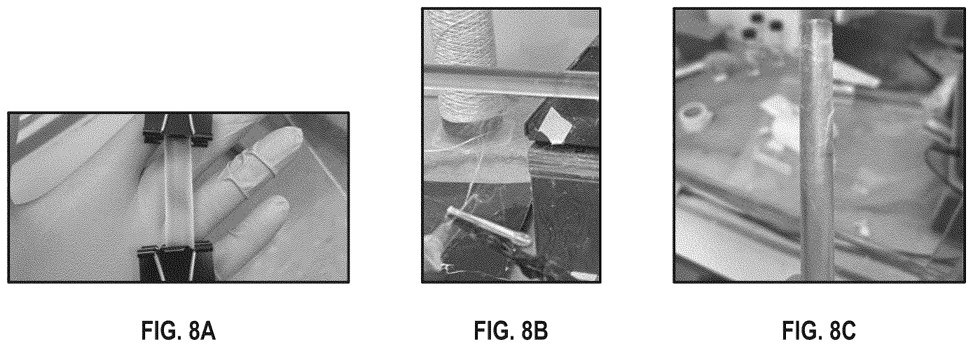

With reference to FIGS. 8A-8C, photographs are provided showing three stages of a coating process for a 3D printed cylindrical graft with gelatin nanofibers. FIG. 8A shows fixing of the solid graft prior to coating (fixing the solid graft between two clips). FIG. 8B shows coating of the graft. FIG. 8C shows the coated graft.

In an embodiment, the electrospinning apparatus/device/system is used to coat fibers with different dimensions. For example, in an embodiment the coating fibers may be nanofibers. In an embodiment, the coating fibers may be microfibers. In an embodiment, the coating fibers may be a combination of nanofibers and microfibers.

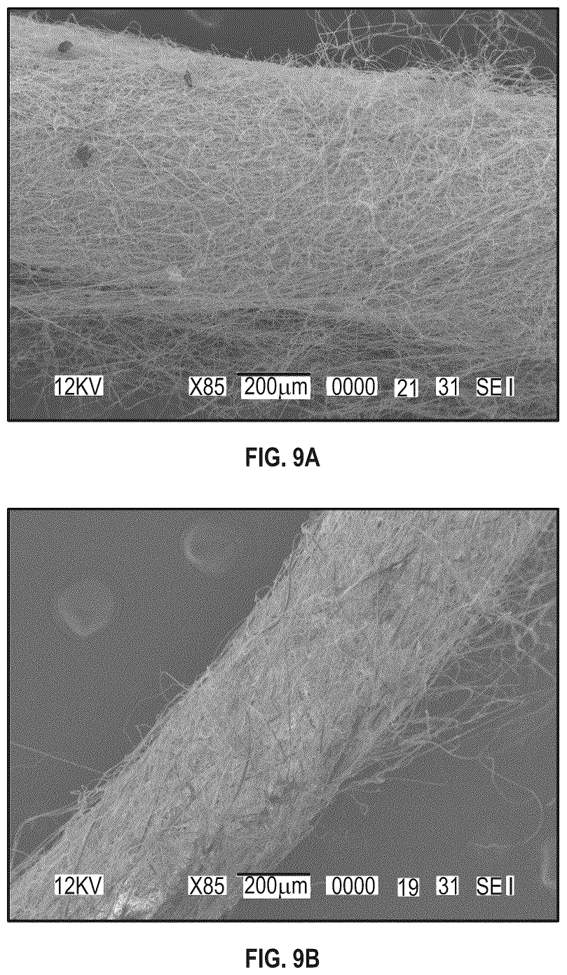

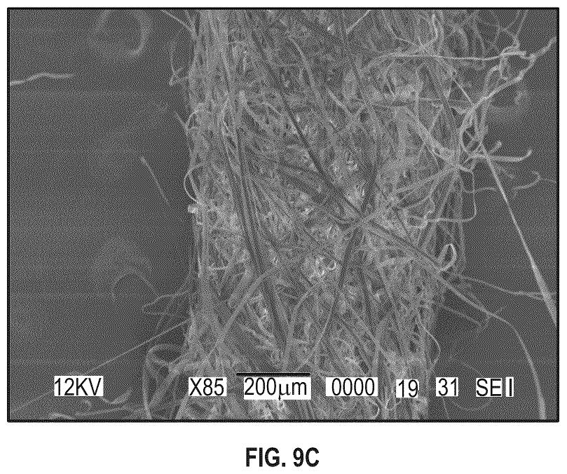

With reference to FIGS. 9A-9C, scanning electron micrographs are providing showing coating with gelatin fibers at different concentrations. In the scanning electron micrograph of FIG. 9A, the gelatin fibers are coated on PLLA yarn at a concentration of about 10%. In the scanning electron micrograph of FIG. 9B, the gelatin fibers are coated on PLLA yarn at a concentration of about 15%. In the scanning electron micrograph of FIG. 9C, the gelatin fibers are coated on PLLA yarn at a concentration of about 20%. The electrospinning conditions for each of the coated yarns shown in FIGS. 9A-9C, the voltage was about 15V, the flow rate was about 1 ml/min, and the distance from needle to the aluminum cylinder was about 10 cm.

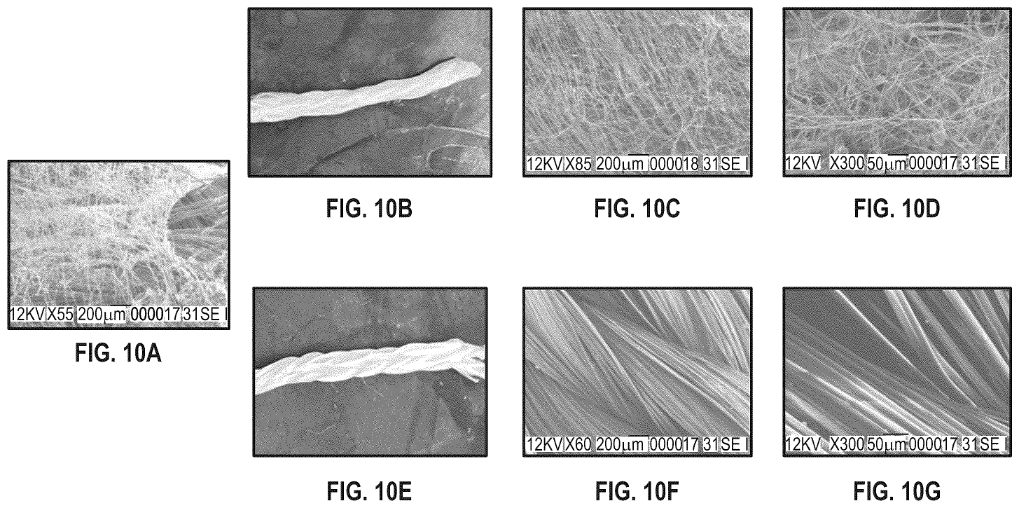

With reference to FIGS. 10A-10G, a series of images are provided showing a coated braided graft region, a bare graft region and the interface therebetween. More specifically, FIG. 10A shows the interface between a coated graft region (as shown in FIGS. 10B-10D) and a bare graft region (as shown in FIGS. 10E-10G) for a braided graft coated made with PLLA yarns that are coated with PLLA nanofibers.

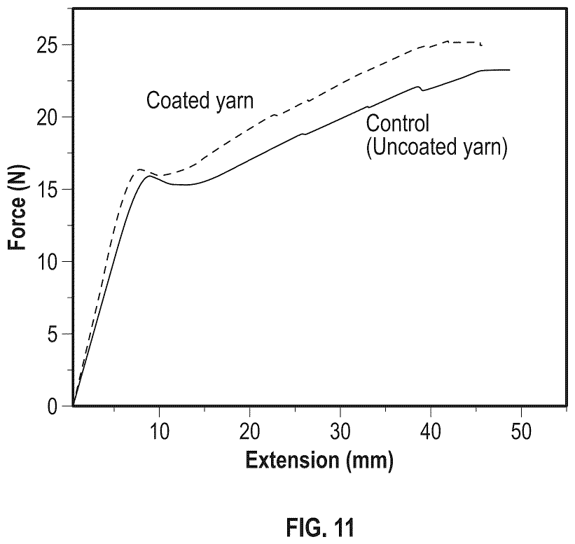

FIG. 11 shows the mechanical properties of PLLA yarns before coating and after coating with PLLA nanofibers. The graph of FIG. 11 demonstrates that the mechanical properties of yarns are similar after coating and before coating. The stress-strain curve comparison between coated and uncoated fibers illustrates that the coating process did not adversely affect the mechanical properties. This data demonstrates that the yarn surface was effectively modified with nanofibers while desired mechanical characteristics of the yarn were maintained.

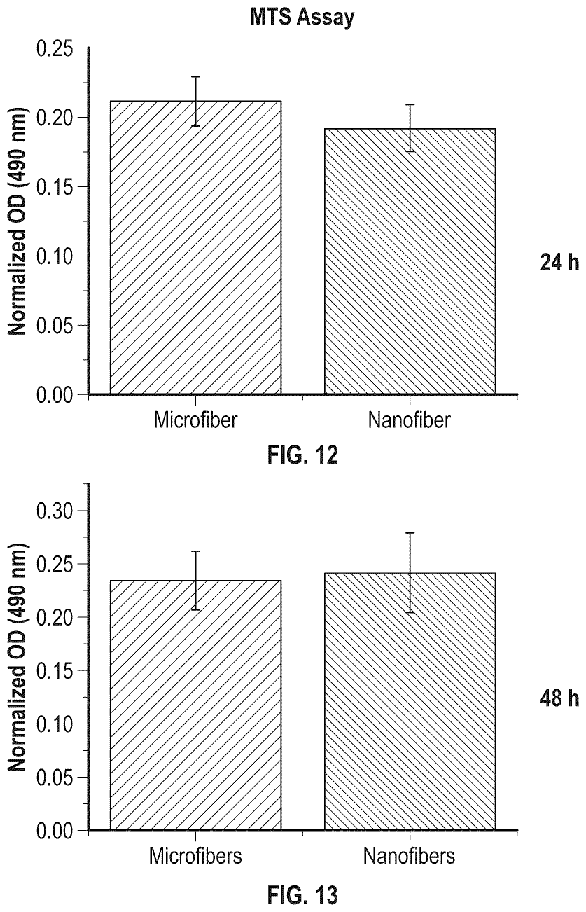

In an embodiment, the electrospinning apparatus is used for coating with nanofibers to improve the micro-environment for cells. Various Live/Dead assays and MTS assays were performed for single fiber and grafts made from multiple fibers using an embodiment of the disclosed apparatus/device/system. Testing was undertaken to assess C2C12 muscle cell attachment and viability after 6 and 12 hours for PLLA yarns coated with PLLA nanofibers and without coating. The live/dead assay results show that cells on coated samples prepared using the electrospinning apparatus/device/system exhibit a higher aspect ratio, suggesting improved cell spreading. The MTS assay results demonstrate that the biocompatibility of coated samples prepared using the electrospinning apparatus is comparable to that of industrial fibers. In addition, proliferation and viability of cells in PLLA industrial yarns and PLLA nanofiber coated yarns after 24 h and 48 h were assessed. C2C12 muscle cells were seeded on the grafts and cell proliferation was studied using MTS assay. With reference to FIG. 12 and FIG. 13, the assays show that coating has no adverse effects on cell proliferation.

In embodiments, in addition to poly-L-lactic acid (PLLA) and polyurethane, other representative synthetic polymers useful for making electrospun fibers include, but are not limited to: silicones, carbonized polyurethane, nylon, polypropylene, polyethylene, polyester, polytetrafluoroethylene (PTFE), poly(glycolic acid), polystyrene, polycarbonate, polyethylene glycol (PEG), fluoropolymers, poly(galactic acid), polyethylene terephthalate (PET), poly(dioxanone), poly(trimethylene carbonate) copolymers, poly(ϵ-caprolactone) homopolymers and copolymers, polyanhydrides, polyorthoesters, and copolymers of any of the foregoing, or a combination thereof. In addition to synthetic fibers, natural fibers, including but not limited to collagen and elastin, or non-synthetic fibers, such as silk, may be electrospun to make non-woven meshes as shown and described herein.

The electrospinning apparatus/device/system may be used to produce non-woven meshes that may be incorporated into medical devices. The apparatus may be used to create a mesh having a fiber architecture that matches the native fibrillar structure (collagen and/or elastin) of the tissue that is to be replaced, so that the structural and mechanical properties of the medical device are similar. A problem with current tissue-engineered structures is that such matching does not exist, leading to a cascade of rejection problems. By using the versatility and control of the electrospinning apparatus as shown and described herein, the desired architectures and mechanical properties can be achieved. Potentially, proteins, ligands, or other structures could be attached to the tissue-engineered structures to enhance performance.

As used herein, the term “medical device,” encompasses two types of devices: (a) a device that is completely or partially implanted into an animal body (such as a human body) during the course of normal operation of the device; and (b) a device that is used as a framework upon which to grow animal cells and/or tissues, either in vivo or ex vivo. Representative examples of medical devices include but are not limited to: prosthetic devices (such as artificial hip joints, artificial ligaments, artificial tendons and artificial knee joints), cardiovascular devices (such as vascular grafts, artificial heart valves and stents), drug delivery devices (e.g., non-implantable drug delivery devices or implantable devices that release one or more drugs over a desired time period), skin substitutes (such as dermal and epidermal scaffolds), scaffolds that support tissue growth (in such anatomical structures as bone, tooth, nerves, pancreas, eye and muscle), implantable biosensors (such as those used to monitor the level of drugs within a living body, or the level of blood glucose in a diabetic patient) and percutaneous devices (such as catheters) that penetrate the skin and link a living body to a medical device, such as a kidney dialysis machine. Some medical devices are completely implanted into an animal body (i.e., the entire device is implanted within an animal body), while some medical devices are partially implanted into an animal body (i.e., only part of the device is implanted within a subject body, the remainder of the device being located outside of the body). Examples of partially implanted medical devices include catheters and skin substitutes. Examples of medical devices that are completely implanted into a living body include stents, artificial heart valves and artificial hip joints. Some medical devices are used as a framework upon which to grow subject cells and/or tissues either in vivo or ex vivo.

The non-woven mesh created by the apparatus/device/system may be deposited directly onto the medical device, or can be formed separately and then attached to medical device, for example by using an adhesive. Representative examples of methods for attaching the non-woven mesh to a medical device include: physioadsorption; lamination with adhesives or heat fusion; electrocharging; static adhesion; “close encapsulation” by wrapping the mesh tightly to the material; covalent attachment via various complementary functional derivatization, e.g., carbodiimide coupling of amines on the medical device to carboxyls on the fibers; ionic derivatization via chemical modification to produce strong electrostatic interaction; and coordination chemistry to bond the mesh to metal via modification with thiols or phenanthrolines.

In an aspect, methods for manufacturing a medical device are provided. For instance, pre-made grafts and materials fabricated using techniques such as braiding, 3D printing, and/or lyophilization, may be coated using the apparatus/device/system with a desired random or parallel nanofiber mesh to enhance function. The methods may include a step of generating an electrostatic field between a first electrode and a second electrode, and electrospinning a dope through a first nozzle and a second nozzle onto a collection surface located between the first and second electrodes, wherein the collection surface influences the deposition of the fibers to lie in a pattern that matches the architecture and structure of a tissue that the mesh is intended to replace.

In an aspect, methods for making a non-woven mesh for a medical device are provided. The methods include generating an electrostatic field between a first electrode and a second electrode. The methods include electrospinning a dope through a first nozzle and a second nozzle onto a collection surface located between the first electrode and the second electrode, wherein the collection surface causes interference with, manipulates, or changes the electrostatic field, and wherein fibers that are deposited on the collection surface are made to lie in a pattern according to the interference, manipulation, or changes in the electrostatic field caused by the collection surface.

In an embodiment, the medical device includes a non-woven mesh made from fibers having fiber diameters of less than about 100 nm to about 10,000 nm. In an embodiment, the medical device includes a non-woven mesh made from fibers having fiber diameters of about 1 nm to about 9999 nm. For example, the medical device includes a non-woven mesh made from fibers having fiber diameters of about 99 nm to about 9500 nm, about 95 nm to about 9000 nm, about 90 nm to about 8500 nm, about 85 nm to about 8000 nm, about 80 nm to about 7500 nm, about 75 nm to about 7000 nm, about 70 nm to about 6500 nm, about 65 nm to about 6000 nm, about 60 nm to about 5500 nm, about 55 nm to about 5000 nm, about 50 nm to about 4500 nm, about 45 nm to about 4000 nm, about 40 nm to about 3500 nm, about 35 nm to about 3000 nm, about 30 nm to about 2500 nm, about 25 nm to about 2000 nm, about 20 nm to about 1500 nm, about 15 nm to about 1000 nm, about 10 nm to about 500 nm, about 5 nm to about 250 nm, about 2 nm to about 150 nm, or about 1 nm to about 100 nm.

In an embodiment, the electrospinning apparatus/device/system is used for coating yarns used in graft fabrication or prefabricated grafts. In an embodiment, the electrospinning apparatus/device/system is used for coating nanofibers onto mechanically robust materials enabling the production of grafts with improved mechanical properties and nanostructures. In an embodiment, the electrospinning apparatus/device/system is used to coat industrial fibers with various types of nanofibers, including those based on natural and synthetic polymers, drug-loaded nanofibers, and/or a combination thereof.

In an embodiment, the electrospinning apparatus/device/system is capable of coating industrial microfibers and prefabricated grafts with synthetic and natural polymer-based nanofibers. In an embodiment, the apparatus/device/system offers precise control over key parameters, including the twister rate, twisting direction (clockwise or counterclockwise), and yarn collection rate.

The apparatus/device/system offers a solution by combining the general extrusion method with subsequent electrospinning coating. The apparatus/device/system allows to retain both the desired mechanical properties and the nanostructure. Additionally, the fibers can be coated with bioactive materials, such as gelatin, resulting in favorable mechanical properties, nanostructure, and bioactivity. In contrast, attempting to make an electrospun sheet of bioactive materials like gelatin and then using electrospinning for nano-yarns would yield inappropriate mechanical properties while being cost-intensive.

In an embodiment, the electrospinning apparatus/device/system serves the purpose of modifying the surface of durable microfibers and/or the grafts through the application of both synthetic and natural nanofibers. In an embodiment, the apparatus/device/system can also be used to fabricate electrospun-based yarns formed by nano to micro-scale fibers. In an embodiment, grafts such as polymeric braids are being used widely as implantable medical devices, and coating the grafts with natural and synthetic nanofibers can significantly enhance the efficacy of the grafts in the body. Similarly, coating microfiber yarns with nanofibers using the disclosed apparatus/device/system can significantly enhances the physical, mechanical, morphological, and biological properties of the yarns. For example, using coated yarns can enhance the efficacy of implantable textile-based constructs, such as woven and knitted scaffolds. The apparatus/device/system offers an improved micro-environment conducive to cellular activities, a crucial aspect for the regeneration of orthopedic tissues such as tendons, and ligaments. The apparatus/device/system and associated methods simultaneously achieve mechanical resilience, nanostructure, and bioactivity.

Employing robust industrial microfibers contributes to the structural strength of the construct, while the incorporation of biologically active nanofibers introduces nano-topographical features that facilitate enhanced cell growth and attachment. Moreover, the inclusion of bioactive components like RGD, commonly found in materials like gelatin, further enhances the biological properties of the construct. This integrated approach addresses the dual requirements of mechanical robustness and cellular interaction necessary for successful regenerative applications in orthopedic contexts.

In an embodiment, the apparatus/device/system enables the coating of the external surface of the graft with nano/microfibers composed of selected polymers (with or without drugs or growth factors). In an embodiment, the apparatus/device/system has the capability to coat yarns, and these coated yarns can be employed in various textile engineering fabrication methods, such as knitting and braiding. In an embodiment, the apparatus/device/system produces nanofibers coating inside and outside of the grafts that are made of coated yarns. In an embodiment, the apparatus/device/system offers temporal and spatial control of coating. In an embodiment, the apparatus/device/system further offers a flexibility to create multiple regions with diverse fibers, varying in dimensions such as nanofibers, microfibers, or a combination thereof. In an embodiment, the apparatus/device/system has capability to coat materials simultaneously with different types of coatings, adding further versatility to the process. In an embodiment, the apparatus/device/system is capable of coating 3-D grafts. In an embodiment, the apparatus/device/system is capable of multiple material applications. In an embodiment, the device is capable of continuous coating process.

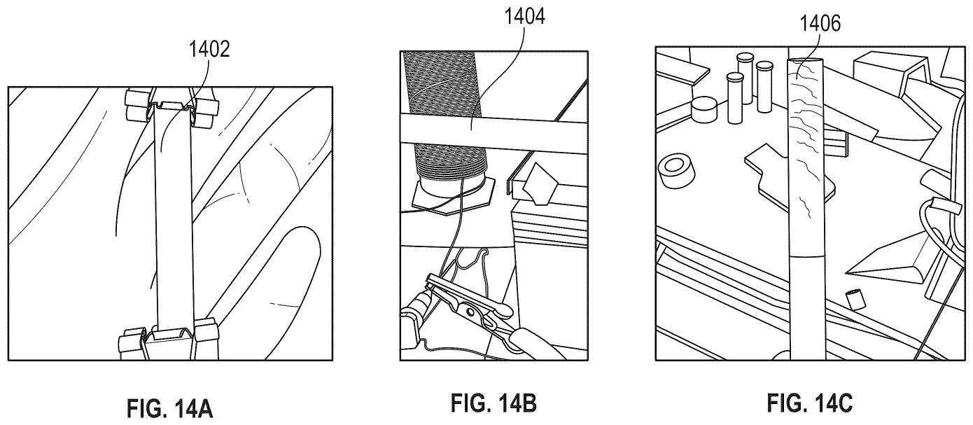

With reference to FIGS. 14A-14C, the apparatus/device/system may be used to coat stiff grafts, including hollow grafts, such as those made by 3D printing. Since twisters are applied at both ends, solid and rigid materials may be used without risking damage during twisting.

FIG. 14A shows a hollow translucent tube 1402 with opening on the side before coating, FIG. 14B shows the hollow translucent tube 1404 during the coating process, and FIG. 14C shows the hollow translucent tube 1406 after coating with nanofibers using an embodiment of the disclosed apparatus/device/system. Coating of the hollow translucent tube demonstrates coating efficacy for a stiff graft, e.g., a hollow/stiff graft.

In an embodiment, the disclosed apparatus/device/system may be used to fabricate/coat hollow, symmetrical and semi-symmetrical, electrospun structures, such as tubes and hollow spheres.

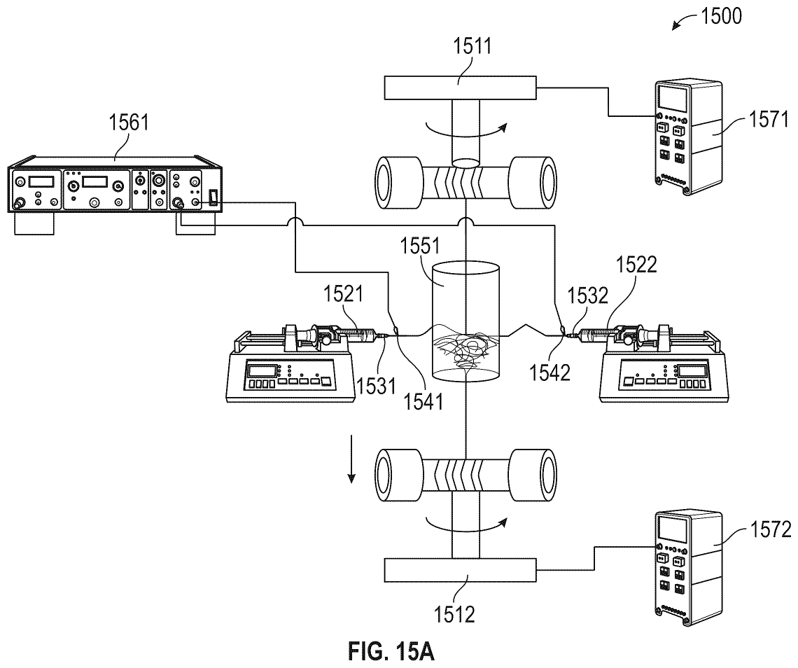

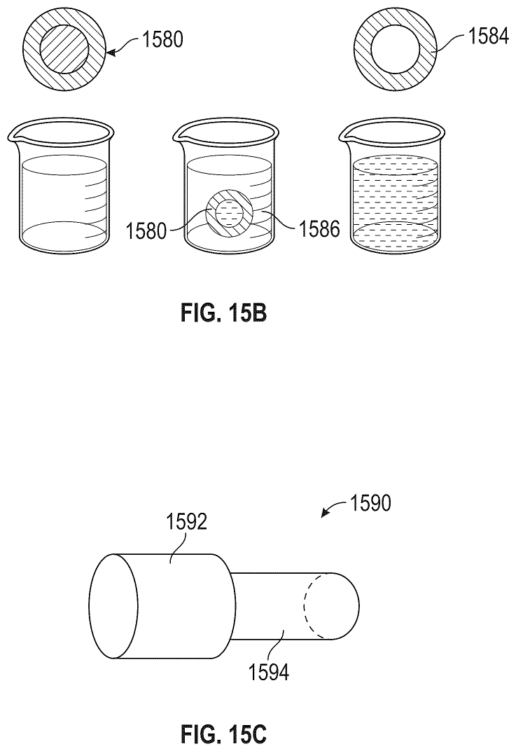

In an embodiment and as shown in FIG. 15A, an apparatus/device/system 1500 for use in fabricating/coating a hollow structure is provided. In an embodiment, the first nozzle 1531 is connected to a first electrode 1541, and the second nozzle 1532 is connected to a second electrode 1542. The first electrode 1541 is grounded or at least at a potential that is lower than a second electrode 1542 that is connected to the second nozzle 1532. For purposes of controlling the spinning dope viscosity, temperature sensor(s) (not shown) may be positioned at the first reservoir 1521 and the second reservoir 1522 to measure the temperature of the first reservoir 1521 and the second reservoir 1522 and/or the dope inside of the first reservoir 1521 and the second reservoir 1522. Heating coils (not shown) may be wrapped around the exterior of the first reservoir 1521 and the second reservoir 1522 to maintain the reservoir and/or the dope at a predetermined temperature. Heating may be provided in various ways, e.g., by electrical heat tracing or tubing provided with a heating medium, such as a hot fluid or steam.

In an embodiment and as shown in FIG. 15, the second electrode 1542 is positioned opposite to the first electrode 1541 and at a distance removed from the first electrode 1541. In an embodiment, the second electrode 1542 is connected to a high voltage power supply (not shown) that applies a high voltage to the second electrode 1542. When the first electrode 1541 is at a potential lower than the second electrode 1542, an electrostatic field is created between the first electrode 1541 and the second electrode 1542, thereby creating generally undisturbed parallel lines of electrostatic force (field lines). In an embodiment, the electrostatic field between the first electrode 1541 and the second electrode 1542 is interfered with, manipulated, or caused to be changed so that desired patterns are created in the electrostatic field lines of force, either by interference with or by the creation of a second electrostatic field, so that the fibers spun via the electrospinning apparatus/device/system 1500 lie according to the patterns created by the interference with, the changes, or the second electrostatic field.

In an embodiment, the electrostatic field created between the first electrode 1541 and the second electrode 1542 is interfered with, manipulated, or changed to have a desirable pattern by a collection surface 1551 that is interposed between the first 1541 and the second 1542 electrodes, so that the collection surface 1551 is isolated from the first 1541 and the second 1542 electrodes. The collection surface 1551 may be electrically isolated from the first 1541 and the second 1542 electrodes.

The method for fabricating/coating a hollow structure may include (i) placing a sacrificial material as the core, e.g., a sacrificial yarn, filament, or rigid material, (ii) coating the core with electrospun nanofibers using the disclosed apparatus/device/system, and (iii) removing the sacrificial material to create a hollow structure.

In an embodiment, a hollow structure may be fabricated by using a solid, non-degradable core (such as a metal). After coating the core with a nanofiber mesh, the mesh can be peeled off and transferred to a collection surface, in the form of a hollow structure.

In an embodiment, the solid core may be designed to be expandable in specific sections along its length, enabling the production of hollow structures with varying diameters.

In an embodiment, a sacrificial component may be coated with nanofibers using the apparatus/device/system 1500 of FIG. 15A, and the sacrificial material 1582 may be removed, e.g., by immersing the structure 1580 in an appropriate solvent 1586 (e.g., water) to form a hollow element 1584, e.g., a hollow tubular structure as shown in FIG. 15B. As schematically depicted in FIG. 15C, the hollow structure(s) 1590 fabricated according to the disclosed method may include hollow materials with different diameters along their lengths, e.g., a larger diameter section 1592 and a smaller diameter section 1594. Additional section(s) of varying diameter(s) may be fabricated.

In an embodiment, the disclosed methods may be used to coat yarns and/or solid grafts with nanofibers that contain various bioactive agents, including drugs, growth factors, or functional materials. For example, nanofibers loaded with a bioactive agent (e.g., PLLA nanofibers loaded with curcumin) may be used to coat structures, e.g., suture yarns, solid microsphere-based grafts, tubes, or lyophilized scaffolds.

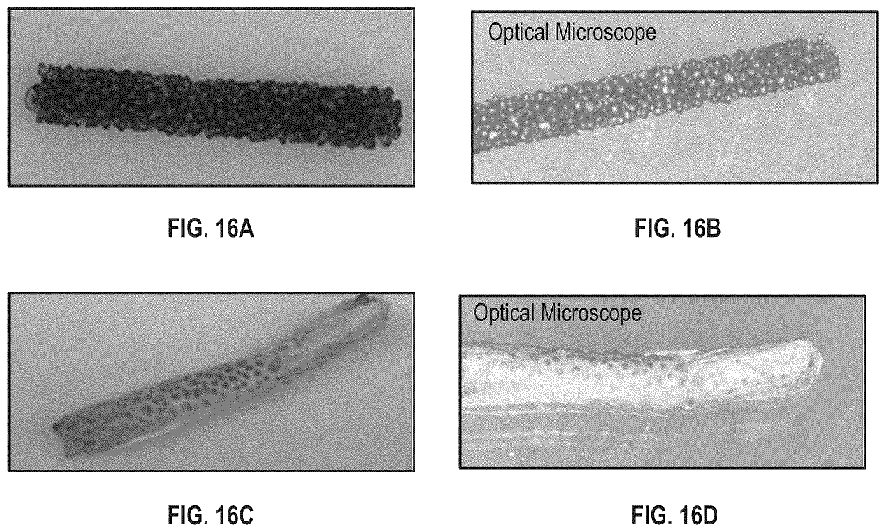

In an embodiment and as shown in FIGS. 16A-16D, a microsphere based graft is shown before coating (FIGS. 16A and 16B), and after coating with curcumin containing PLLA nanofibers (FIGS. 16C and 16D) using an embodiment of the disclosed apparatus/device/system.

The disclosed coating methodology is versatile and can incorporate other agents, such as different therapeutic drugs, growth factors, or materials like hydroxyapatite, and graphene, thereby enabling fabrication of multifunctional biomedical devices tailored for specific applications.

In an embodiment, production of tubes with varying diameters along their length may be undertaken, thereby supporting diverse design needs and opportunities. Production and coating of tubular structures according to the foregoing method provides a scalable method for mass-producing hollow structures/products for a range of applications, including biomedical and industrial applications.

In an embodiment, a method is provided for coating porous, prefabricated tubing, e.g., for filtration applications. In an embodiment, the method may include (i) providing a prefabricated tube containing pores or perforations, and (ii) coating the tube with nanofibers with various utilities, e.g., for utility in filtration applications (e.g., with functional surface chemistries or targeted pore sizes), using the disclosed apparatus/device system. In a filtration embodiment, when passing a fluid or gas through the coated tube, the nanofiber layer may act as a filtration barrier, trapping or capturing particles, contaminants, or specific molecules. In an embodiment, this approach enables the production of advanced, customizable filters for medical, industrial, or environmental applications.

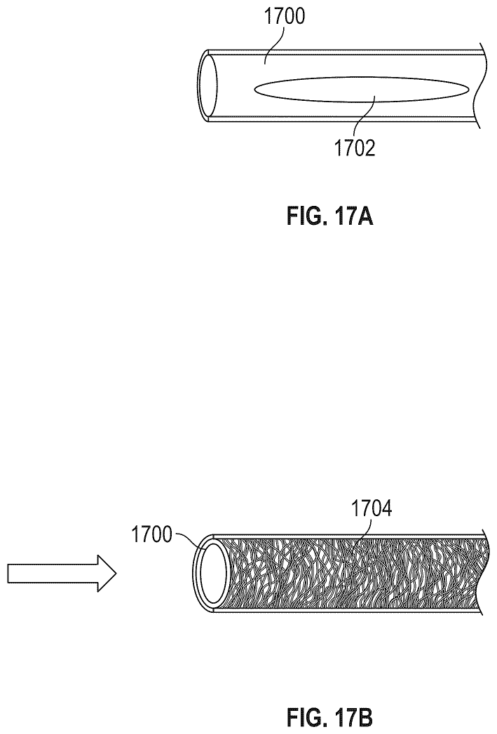

As shown in FIG. 17A, a tube 1700 with an opening 1702 in its side may be coated with nanofibers 1704, as shown in FIG. 17B. Thereafter, the nanofiber coated layer may act as a filtration barrier as fluid/gas is passed therethrough.

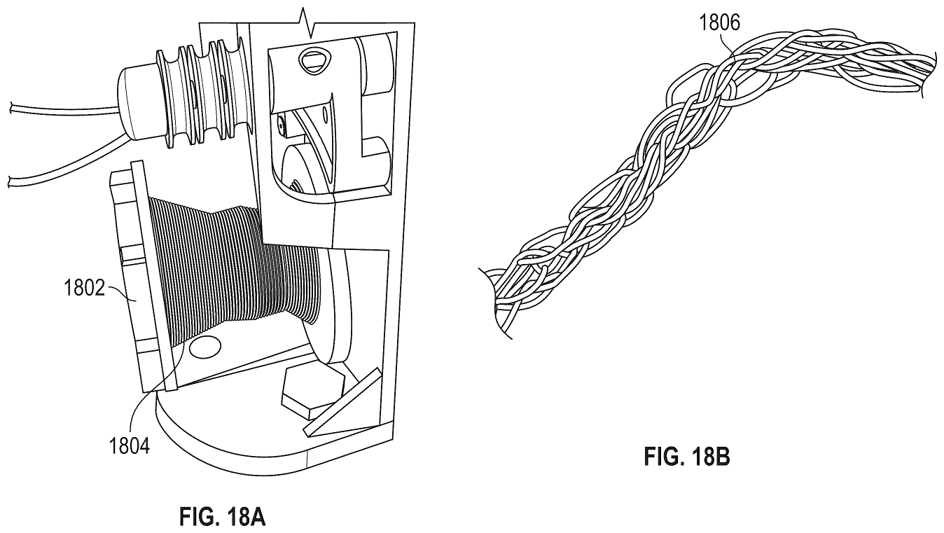

FIG. 18A shows a PLLA yarn 1804 on a twister 1802 that is coated with curcumin drug-containing PLLA nanofibers using an embodiment of the disclosed apparatus/device/system. FIG. 18B shows a knitted graft 1804 made with the coated yarn shown in FIG. 18A.

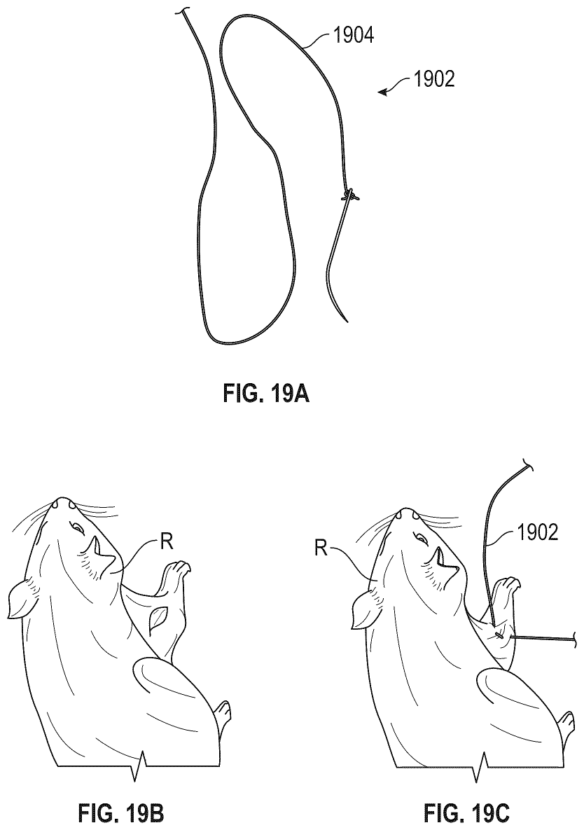

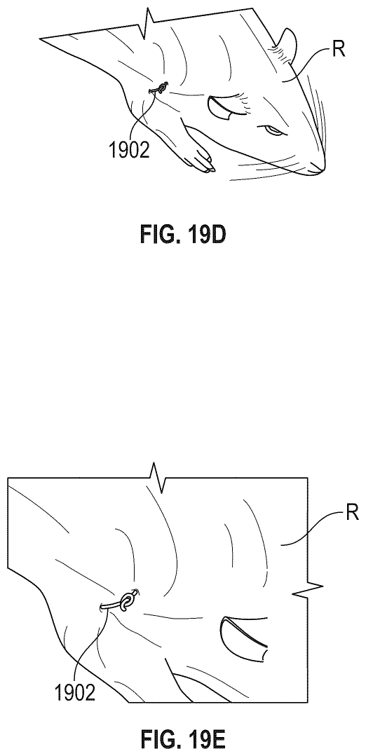

FIG. 19A shows a needled suture 1902 fabricated from a curcumin-PLLA nanofiber coated yarn 1904 fabricated using an embodiment of the disclosed apparatus/device/system. FIGS. 19B-19E show various steps in the suturing of a cadaveric rat R using the needled suture 1902 of FIG. 19A.

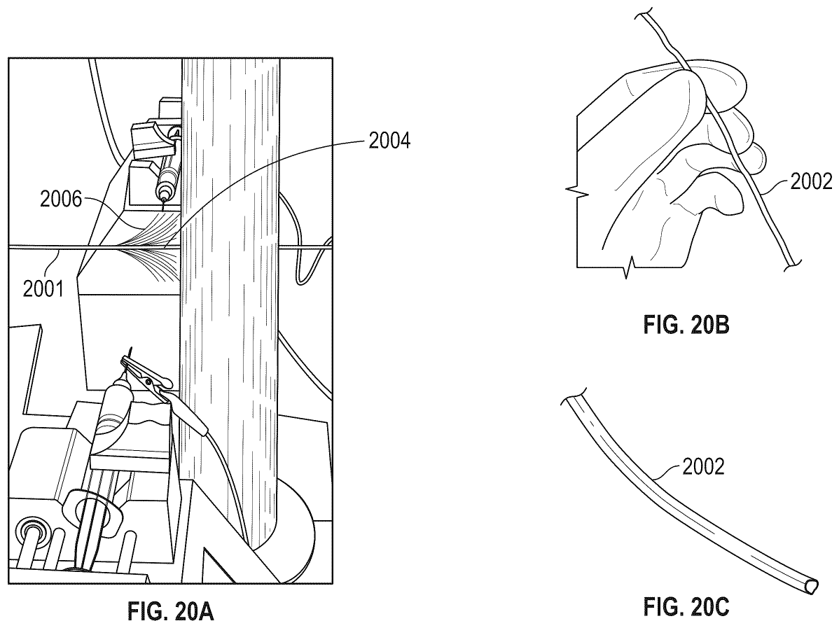

FIG. 20A shows a system 2000 for fabrication of a hollow tube 2002 that is coated with PLLA nanofibers 2006. A polyvinyl alcohol (PVA) sacrificial filament 2004 is included with the initial cylindrical structure 2001 during the coating process. Subsequently, the sacrificial filament 2004 is removed, e.g., by dissolving in water. Dissolution of the sacrificial filament 2004 yields hollow tube 2002, as shown in FIG. 20B and FIG. 20C.

The apparatus/device/system and associated methods are illustrated and further described with reference to the following non-limiting example.

### EXAMPLE

### Materials

Poly (L-lactide) (PLLA, inherent viscosity 2.0-2.7 dl/g) was purchased from Corbion Purac (KS, USA). Gelatin type A was procured from MP Biomedicals, USA. 1,1,1,3,3,3-Hexa-fluoro-2-propanol (HFIP) was purchased from Sigma-Aldrich (MO, USA). PLLA yarns were obtained from Teleflex company.

### Electrospinning Method

The electrospinning solution was prepared by dissolving 10% PLLA (or about 4%, 10%, 15%, and 20% gelatin) in HFIP solvent and allowing it to dissolve overnight. Following this, two syringes were loaded with the solution and they were connected to the electrospinning pumps. These pumps were then positioned on opposite sides of an aluminum cylinder, functioning as the grounding element. Needles from the two syringes were connected to terminals with opposite charge voltages.

Subsequently, a bobbin containing industrial microfibers was positioned behind the aluminum cylinder. Both the feeding of yarn and the electrospinning process were initiated simultaneously. Due to the opposing charges, the electrospun yarns adhered to the microfibers, facilitating the subsequent process of twisting and collection onto a collector. This mechanism allowed for precise control over the twisting and collection rates.

Through this setup, it became feasible to achieve high-volume production of microfibers featuring a nanostructured surface, with considerable potential for applications in the field of regenerative engineering.

For reasons of completeness, various aspects of the disclosure are set out in the following numbered clauses:
Clause 1: An electrospinning system, comprising:
   a. a first twister for feeding a fibrous element to a coating region;
   b. a reservoir configured to contain a spinning dope;
   c. a nozzle in fluid communication with the reservoir for delivery of the spinning dope to the coating region;
   d. at least a first electrode and a second electrode in spaced relation;
   e. a power supply in electrical communication with at least one of the first electrode and the second electrode,
   f. at least one collection surface located between the first electrode and the second electrode; and
   g. a second twister for collecting the fibrous element subsequent to coating within the coating region
   wherein the power supply is configured to generate an electrostatic field in the coating region between the first electrode and the second electrode.
Clause 2: The electrospinning system of clause 1, further comprising a first control panel for controlling a twisting rate of the first twister.
Clause 3: The electrospinning apparatus of clause 2, further comprising a second control panel for controlling at least one of a twisting rate and a collection rate of the second twister.
Clause 4: The electrospinning apparatus of clause 3, wherein the second control panel is encompassed within the first control panel.
Clause 5: The electrospinning apparatus of clause 1, wherein the first nozzle is a syringe needle.
Clause 6: The electrospinning apparatus of clause 1, wherein the first nozzle is in physical contact with the first electrode.
Clause 7: The electrospinning apparatus of clause 1, further comprising a first pump in fluid communication with the first reservoir for delivering the spinning dope to the nozzle.
Clause 8: The electrospinning apparatus of clause 1, further comprising:
   a. a second reservoir configured to contain a second spinning dope;
   b. a second nozzle in fluid communication with the second reservoir for delivery of the second spinning dope to the coating region.
Clause 9: The electrospinning apparatus of clause 8, further comprising second pump in fluid communication with the second reservoir for delivering the second spinning dope to the second nozzle.
Clause 10: The electrospinning apparatus of clause 8, wherein the spinning dope and the second spinning dope are the same material.
Clause 11: The electrospinning apparatus of clause 8, wherein the spinning dope and the second spinning dope are different materials.
Clause 12: The electrospinning apparatus of clause 1, further comprising a plurality of additional nozzles and a plurality of additional reservoirs, wherein each of the plurality of additional nozzles is in fluid communication with one of the additional reservoirs.
Clause 13: The electrospinning apparatus of clause 12, wherein the plurality of additional nozzles comprise 2, 4, 6, 8, 10, 12, 14, 16, 18 or 20 additional nozzles, and wherein the plurality of additional reservoirs comprise 2, 4, 6, 8, 10, 12, 14, 16, 18 or 20 additional reservoirs.
Clause 14: The electrospinning apparatus of clause 1, further comprising a plurality of additional electrodes.
Clause 15: The electrospinning apparatus of clause 14, wherein the plurality of additional electrodes comprise 2, 4, 6, 8, 10, 12, 14, 16, 18 or 20 additional electrodes.
Clause 16: The electrospinning apparatus of clause 1, further comprising a plurality of pumps.
Clause 17: The electrospinning apparatus of clause 16, wherein the plurality of pumps comprise 2, 4, 6, 8, 10, 12, 14, 16, 18 or 20 pumps.
Clause 18: The electrospinning apparatus of clause 1, wherein the at least one collection surface comprises one to ten collection surfaces.
Clause 19: A method for coating a fibrous element with coating material, comprising:
   a. feeding the fibrous element to a coating region that is between a first electrode and a second electrode, that includes at least one collection surface and that is subject to an electrostatic field,
   b. delivering a spinning dope to the coating region to coat the fibrous element;
   c. collecting the coated fibrous element.
Clause 20: The method of clause 19, wherein the fibrous element is selected from a yarn, a microfiber and a prefabricated graft.
Clause 21: The method of clause 19, wherein the coating comprises a synthetic or natural polymer-based nanofiber or micro-fiber.
Clause 22: A method for coating a hollow element with coating material, comprising:
   a. positioning the hollow element in a coating region that is between a first electrode and a second electrode, that includes at least one collection surface and that is subject to an electrostatic field, and
   b. delivering a spinning dope to the coating region to coat the hollow element.
Clause 23: The method of clause 22, wherein the hollow element is a tubular element that includes an opening in its side.
Clause 24: The method of clause 22, wherein the hollow element includes a sacrificial element positioned therewithin during the spinning dope delivery step.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Any combination of the above-described elements in all possible variations thereof is encompassed by the invention unless otherwise indicated herein or otherwise clearly contradicted by context.

The following terms are used to describe the invention of the present disclosure. In instances where a term is not specifically defined herein, that term is given an art-recognized meaning by those of ordinary skill applying that term in context to its use in describing the present disclosure.

Unless otherwise defined, all technical and scientific terms used herein have the same meaning as commonly understood by one of ordinary skill in the art. For example, any nomenclatures used in connection with, and techniques of, cell and tissue culture, molecular biology, immunology, microbiology, genetics, and protein and nucleic acid chemistry and hybridization described herein are well known and commonly used in the art. In case of conflict, the present disclosure, including definitions, will control. Exemplary methods and materials are described below, although methods and materials similar or equivalent to those described herein can be used in practice or testing of the embodiments and aspects described herein.

Compounds and materials are described using standard nomenclature. Unless defined otherwise, all technical and scientific terms used herein have the same meaning as is commonly understood by one of skill in the art to which this invention belongs. The following terms are used to describe the invention of the present disclosure. In instances where a term is not specifically defined herein, that term is given an art-recognized meaning by those of ordinary skill applying that term in context to its use in describing the present disclosure.

The use of the terms “a” and “an” and “the” and similar referents (especially in the context of the following claims) are to be construed to cover both the singular and the plural, unless otherwise indicated herein or clearly contradicted by context. By way of example, “an element” means one element or more than one element.

As used herein, the term “substantially” means to a great or significant extent, but not completely.

The term “subject” is used herein to refer to an animal, such as a mammal, including a primate (such as a human, a non-human primate, e.g., a monkey, and a chimpanzee), a non-primate (such as a cow, a pig, a camel, a llama, a horse, a goat, a rabbit, a sheep, a hamster, a guinea pig, a cat, a dog, a rat, a mouse, and a whale), a bird (e.g., a duck or a goose), and a shark. In an embodiment, the subject is a human, such as a human being treated or assessed for a disease, disorder or condition, a human at risk for a disease, disorder or condition, a human having a disease, disorder or condition, and/or human being treated for a disease, disorder or condition as described herein. In some embodiments, the subject does not suffer from an ongoing autoimmune disease. In one embodiment, the subject is about 1, 2, 3, 4, 5, 6, 7, 8, 9, or 10 years of age. In another embodiment, the subject is about 5-10, 10-15, 15-20, 20-25, 25-30, 30-35, 35-40, 40-45, 45-50, 50-55, 55-60, 60-65, 65-70, 70-75, 75-80, 80-85, 85-90, 90-95, 95-100 years of age. Values and ranges intermediate to the above recited ranges are also intended to be part of this invention. In addition, ranges of values using a combination of any of the above-recited values as upper and/or lower limits are intended to be included.

It should also be understood that, in certain methods described herein that include more than one step or act, the order of the steps or acts of the method is not necessarily limited to the order in which the steps or acts of the method are recited unless the context indicates otherwise. Furthermore, the terms first, second, etc., as used herein are not meant to denote any particular ordering, but simply for convenience to denote a plurality of, for example, layers.

The terms “comprising”, “having”, “including”, and “containing” are to be construed as open-ended terms (i.e., meaning “including, but not limited to”) unless otherwise noted.

The terms “about” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or 5% of the stated value. Recitation of ranges of values are merely intended to serve as a shorthand method of referring individually to each separate value falling within the range, unless otherwise indicated herein, and each separate value is incorporated into the specification as if it were individually recited herein. All ranges disclosed herein include both end points as discrete values as well as all integers and fractions specified within the range. For example, a range of 0.1-2.0 includes 0.1, 0.2, 0.3, 0.4 . . . 2.0. All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non- claimed element as essential to the practice of the invention as used herein.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “one or more,” as used herein, means at least one, and thus includes individual components as well as mixtures/combinations of the listed components in any combination.

Other than in the operating examples, or where otherwise indicated, all numbers expressing quantities of ingredients and/or reaction conditions are to be understood as being modified in all instances by the term “about,” meaning within 10% of the indicated number (e.g., “about 10%” means 9%-11% and “about 2%” means 1.8%-2.2%).

All percentages and ratios are calculated by weight unless otherwise indicated. All percentages are calculated based on the total composition unless otherwise indicated. Generally, unless otherwise expressly stated herein, “weight” or “amount” as used herein with respect to the percent amount of an ingredient refers to the amount of the raw material comprising the ingredient, wherein the raw material may be described herein to comprise less than and up to 100% activity of the ingredient. Therefore, weight percent of an active in a composition is represented as the amount of raw material containing the active that is used and may or may not reflect the final percentage of the active, wherein the final percentage of the active is dependent on the weight percent of active in the raw material.

All ranges and amounts given herein are intended to include subranges and amounts using any disclosed point as an end point. Thus, a range of “1% to 10%, such as 2% to 8%, such as 3% to 5%,” is intended to encompass ranges of “1% to 8%,” “1% to 5%,” “2% to 10%,” and so on. All numbers, amounts, ranges, etc., are intended to be modified by the term “about,” whether or not so expressly stated. Similarly, a range given of “about 1% to 10%” is intended to have the term “about” modifying both the 1% and the 10% endpoints. Further, it is understood that when an amount of a component is given, it is intended to signify the amount of the active material unless otherwise specifically stated.

As used herein, “optional” or “optionally” means that the subsequently described event or circumstance may or may not occur, and that the description includes instances where said event or circumstance occurs and instances where it does not.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein. Unless defined otherwise, technical and scientific terms used herein have the same meaning as is commonly understood by one of skill in the art of this disclosure.

Furthermore, the disclosure encompasses all variations, combinations, and permutations in which one or more limitations, elements, clauses, and descriptive terms from one or more of the listed claims are introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group.

All compounds are understood to include all possible isotopes of atoms occurring in the compounds. Isotopes include those atoms having the same atomic number but different mass numbers and encompass heavy isotopes and radioactive isotopes. By way of general example, and without limitation, isotopes of hydrogen include tritium and deuterium, and isotopes of carbon include ¹¹C, ¹³C, and ¹⁴C. Accordingly, the compounds disclosed herein may include heavy or radioactive isotopes in the structure of the compounds or as substituents attached thereto. Examples of useful heavy or radioactive isotopes include ¹⁸F, ¹⁵N, ¹⁸O, ⁷⁶Br, ¹²⁵I and ¹³¹I.

A significant change is any detectable change that is statistically significant in a standard parametric test of statistical significance such as Student's t-test, where p<0.05.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Any combination of the above-described elements in all possible variations thereof is encompassed by the invention unless otherwise indicated herein or otherwise clearly contradicted by context.

### Incorporation by Reference

All U.S. and PCT patent publications and U.S. patents mentioned herein are hereby incorporated by reference in their entirety as if each individual patent publication or patent was specifically and individually indicated to be incorporated by reference. In case of conflict, the present application, including any definitions herein, will control.

### Other Embodiments

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

What is claimed is:

1. An electrospinning system, comprising:
a. a first twister for feeding a fibrous element to a coating region;
b. a reservoir configured to contain a spinning dope;
c. a nozzle in fluid communication with the reservoir for delivery of the spinning dope to the coating region;
d. at least a first electrode and a second electrode in spaced relation;
e. a power supply in electrical communication with at least one of the first electrode and the second electrode, f. at least one collection surface located between the first electrode and the second electrode; and
g. a second twister for collecting the fibrous element subsequent to coating within the coating region
wherein the power supply is configured to generate an electrostatic field in the coating region between the first electrode and the second electrode.

2. The electrospinning system of claim 1, further comprising a first control panel for controlling a twisting rate of the first twister.

3. The electrospinning apparatus of claim 2, further comprising a second control panel that is incorporated within or is distinct from the first control panel, wherein the second control panel controls at least one of a twisting rate and a collection rate of the second twister.

4. The electrospinning apparatus of claim 1, wherein the first nozzle is a syringe needle.

5. The electrospinning apparatus of claim 1, wherein the first nozzle is in physical contact with the first electrode.

6. The electrospinning apparatus of claim 1, further comprising a first pump in fluid communication with the first reservoir for delivering the spinning dope to the nozzle.

7. The electrospinning apparatus of claim 1, further comprising:
a. a second reservoir configured to contain a second spinning dope; and
b. a second nozzle in fluid communication with the second reservoir for delivery of the second spinning dope to the coating region.

8. The electrospinning apparatus of claim 7, further comprising second pump in fluid communication with the second reservoir for delivering the second spinning dope to the second nozzle.

9. The electrospinning apparatus of claim 7, wherein the spinning dope and the second spinning dope are the same material or are different materials.

10. The electrospinning apparatus of claim 1, further comprising a plurality of additional nozzles and a plurality of additional reservoirs, wherein each of the plurality of additional nozzles is in fluid communication with one of the additional reservoirs.

11. The electrospinning apparatus of claim 10, wherein the plurality of additional nozzles comprise 2, 4, 6, 8, 10, 12, 14, 16, 18 or 20 additional nozzles, and wherein the plurality of additional reservoirs comprise 2, 4, 6, 8, 10, 12, 14, 16, 18 or 20 additional reservoirs.

12. The electrospinning apparatus of claim 1, further comprising a plurality of additional electrodes and/or a plurality of pumps.

13. The electrospinning apparatus of claim 12, wherein the plurality of additional electrodes comprise 2, 4, 6, 8, 10, 12, 14, 16, 18 or 20 additional electrodes, and/or wherein the plurality of pumps comprises 2, 4, 6, 8, 10, 12, 14, 16, 18 or 20 pumps.

14. The electrospinning apparatus of claim 1, wherein the at least one collection surface comprises one to ten collection surfaces.

15. A method for coating a fibrous element with coating material, comprising:
a. feeding the fibrous element to a coating region that is between a first electrode and a second electrode, that includes at least one collection surface and that is subject to an electrostatic field,
b. delivering a spinning dope to the coating region to coat the fibrous element;
c. collecting the coated fibrous element.

16. The method of claim 15, wherein the fibrous element is selected from a yarn, a microfiber and a prefabricated graft.

17. The method of claim 15, wherein the coating comprises a synthetic or natural polymer-based nanofiber or micro-fiber.

18. A method for coating a hollow element with coating material, comprising:
a. positioning the hollow element in a coating region that is between a first electrode and a second electrode, that includes at least one collection surface and that is subject to an electrostatic field, and
b. delivering a spinning dope to the coating region to coat the hollow element.

19. The method of claim 18, wherein the hollow element is a tubular element that includes an opening in its side.

20. The method of claim 18, wherein the hollow element includes a sacrificial element positioned therewithin during the spinning dope delivery step.
